(19) United States
(12) Patent Application Publication
(10) Pub. No.: US 2007/0227676 A1
(43) Pub. Date: Oct. 4, 2007

(54) Window assembly having retractable screen

(75) Inventor: Mike Hugh Legay, Auburn, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Royal Group Technologies Limited

(21) Appl. No.: 10/951,338

(22) Filed: Sep. 27, 2004

(51) Int. Cl. E06B 7/03

(52) U.S. Cl. 160/102

(57) ABSTRACT

A window assembly incorporating a retractable screen assembly is provided. The window assembly includes an external frame configured to interface with a rectangular opening in a wall. The frame defines a central channel on an inwardly facing side of the frame. The window assembly further includes a stationary panel and a sliding panel deposed within the frame. The stationary panel includes a glazing bead received within a portion of the central channel adjacent to the stationary panel to facilitate secure positioning of the panel. The sliding panel is configured to slide within the confines of the frame between open and closed positions. The retractable screen assembly includes a spool and a screen rolled about the spool, the screen having a leading end coupled to the sliding panel such that the screen is aligned along the central channel as the sliding panel slides between open and closed positions, the screen assembly having a portion disposed within the central channel.

### BACKGROUND OF THE INVENTION

The present invention relates generally to windows and, more particularly, to windows having retractable screens.

Window screens have long been used with windows having sliding panels, e.g., single-hung and slider windows. The screens are typically formed of a woven mesh of metal, plastic, or fiberglass stretched across an outer frame. In most applications, the mesh is sized to inhibit insects. Thus, to be effective, the mesh must be tightly woven. In use, the screens typically are mounted to an external side of a window without inhibiting the operation of sliding panel of the window. The screen typically are left in place, whether the panel is open or closed. Thus, even with the window closed, view out the window is inhibited. Many consider such screens to be rather unattractive.

Due in parts to these concerns, retractable screens have become increasingly popular. In current designs, retractable screens typically include a rolled screen assembly and a pair of parallel tracks for receiving the longitudinal edges of the screen, all externally attached to the window frame. The tracks extend from opposing sides of the rolled screen assembly and are dedicated to retaining the screen as it is unrolled and extended across the frame. The leading edge of the screen typically includes a handle so that a user can manually open and close the screen. In certain designs, the retractable screen is installed into the window frame from the interior side of the window frame, making it accessible to users within the building. Such designs typically require the window frame to be relatively oversized to accommodate the screen assembly. Although, generally effective, in current designs the window and screen assembly can lack esthetic appeal or may require substantial effort for installation.

It should, therefore, be appreciated that there remains a need for a window incorporating a retractable screen having an esthetic look that is cost-effective to manufacture and is easy to use. The present invention fulfills this need and others.

### SUMMARY OF THE INVENTION

The invention resides in a window assembly incorporating a retractable screen assembly. The window assembly includes an external frame configured to interface with a rectangular opening in a wall. The window frame defines a central channel on an inwardly facing side of the frame. The window assembly further includes a stationary panel and a sliding panel deposed within the frame. The stationary panel includes a glazing bead received within a portion of the central channel adjacent to the stationary panel to facilitate secure positioning of the panel. The sliding panel is configured to slide within the confines of the frame between open and closed positions. The retractable screen assembly includes a spool and a screen rolled about the spool, the screen having a leading edge coupled to the sliding panel such that the screen is aligned along the central channel as the sliding panel slides between open and closed positions, the screen assembly having a portion disposed within the central channel.

In an exemplary embodiment of the invention, the frame defines a first sash pocket for receiving the stationary panel and a second sash pocket for receiving the sliding panel, the first and second sash pockets aligned parallel to one another on opposing sides of the central channel. The frame preferably defines two central channels spaced from each other on opposing sides of the frame.

In a detailed aspect of an exemplary embodiment, the screen assembly includes a side edge disposed within the central channel. The leading edge of the screen is attached to a pull rail that is removably attached to the sliding panel via a snap-fit. The pull rail includes an end portion disposed within the central channel such that the central channel confines operable movement of the pull rail.

In another exemplary embodiment of the invention, the window assembly includes an external frame having first and second pairs of opposing sides. Each side of the first pair defines first and second sash pockets aligned parallel with each other along the length of the side along an inwardly facing side thereof, and each side further defines a central channel disposed between the first and second sash pockets. The second pair of opposing sides is attached perpendicular to the first pair of opposing sides. The window assembly includes a stationary panel secured to the frame within the first sash pockets of the first pair of opposing sides and a sliding panel disposed within the second sash pockets of the frame. The sliding panel is configured to slide within the confines of the frame between open and closed positions. The retractable screen assembly includes a housing secured along a first side of the second pair of opposing sides. A spool is mounted for rotation within an elongated cavity of the housing. A screen rolled about the spool. The screen has a leading end coupled to the sliding panel such that the screen is aligned along the central channel as the sliding panel slides between open and closed positions, the screen assembly having a portion disposed within the central channel.

In a detailed aspect of an exemplary embodiment, the central channel of each of the sides of the first pair extends substantially the length thereof. The stationary panel can also include two glazing beads, in which each glazing bead is received within a portion of the corresponding central channel adjacent to the stationary panel.

In another detailed aspect of an exemplary embodiment, the screen assembly is a self-contained component and features its own housing separate from the window such that it can be inserted into and removed from the exterior side of the window frame.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is an elevational view of a window assembly having a retractable screen assembly in accordance with the invention, depicting a sliding panel of the window assembly partially open.

FIG. 2 is a cross-sectional view, taken along line A-A, of the window assembly of FIG. 1, depicting the screen assembly having a housing attached to the external frame and a pull rail attached to the sliding panel.

FIG. 3 is a close-up, cross-sectional view of area B from FIG. 2.

FIG. 4 is a close-up, cross-sectional view of area C from FIG. 3, depicting the attachment of the pull rail to the sliding panel.

FIG. 5 is an elevated view of the window assembly of FIG. 1, depicting the sliding panel closed.

FIG. 6 is a cross-sectional view, taking along line D-D of FIG. 5.

FIG. 7 is a close-up cross-sectional view of area E of FIG. 6, depicting the pull rail adjacent to the housing with the sliding panel closed.

FIG. 8 is a close-up, cross-sectional view of area F of FIG. 7, depicting the attachment of the pull rail, screen, and sliding panel.

FIG. 9 is a cross-sectional view taken along line G-G of FIG. 5.

FIG. 10 is a close-up, cross-sectional view of area H of FIG. 9, depicting a glazing bead for holding the stationary panel in place disposed in a central channel of the external frame.

FIG. 11 is a cross-sectional view taken along line I-I of FIG. 5.

FIG. 12 is a close-up, cross-sectional view of area J of FIG. 11, depicting a cap of the pull rail disposed in the central channel.

### DETAILED DESCRIPTION OF THE PREFERRED EMBODIMENTS

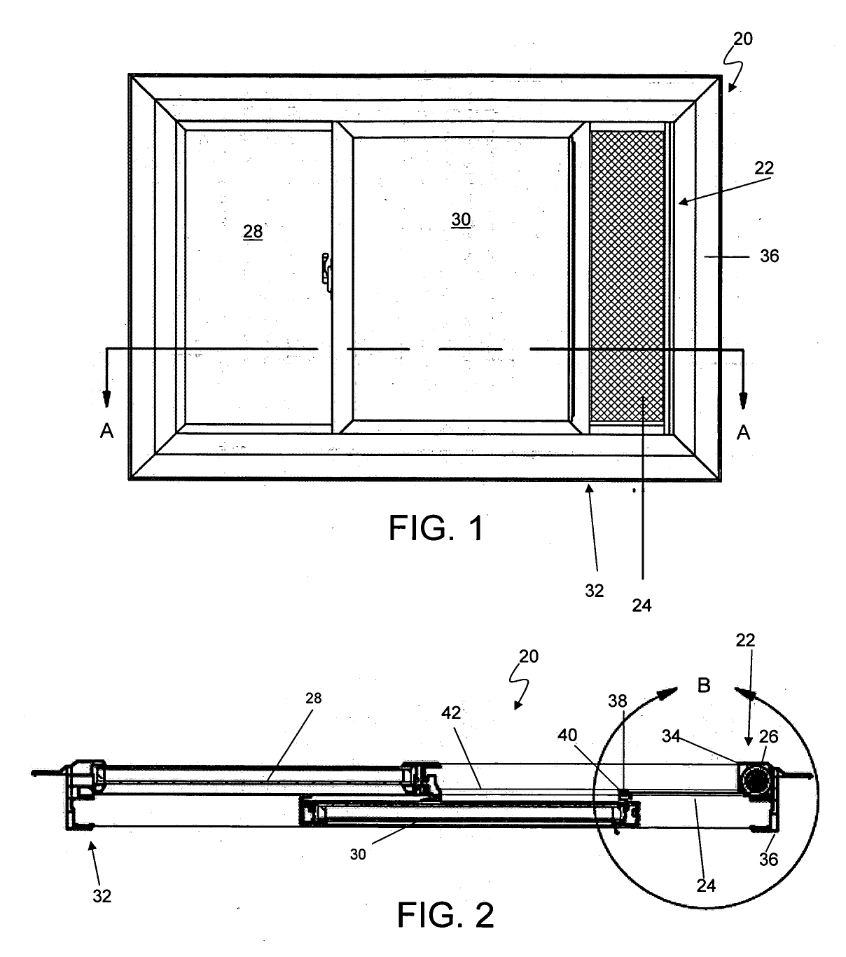

With reference now to the drawings, and particularly FIGS. 1 and 2, there is shown a sliding window assembly 20 having a retractable screen assembly 22 incorporating a mesh screen 24 rolled about a spool 26. The window assembly includes a stationary panel 28 and a sliding panel 30 disposed within an external frame 32. In the exemplary embodiment, the sliding panel slides horizontally along the frame. The screen and spool combination are mounted within a housing 34 disposed along a first vertical side 36 of the frame, and a leading edge 38 (FIG. 2) of the screen is attached to the sliding panel via a pull rail 40. Thus, as the sliding panel is slid open, the screen is pulled along behind, without need for separate operation of both he sliding panel and the retractable screen. As the screen is extended, it remains confined within borders of the frame. The screen is aligned to travel along a central channel 42 (FIG. 2), shared with the stationary panel. The central channel serves a dual purpose for use as both a guide for the screen pull rail and as a glazing bead pocket for the stationary panel.

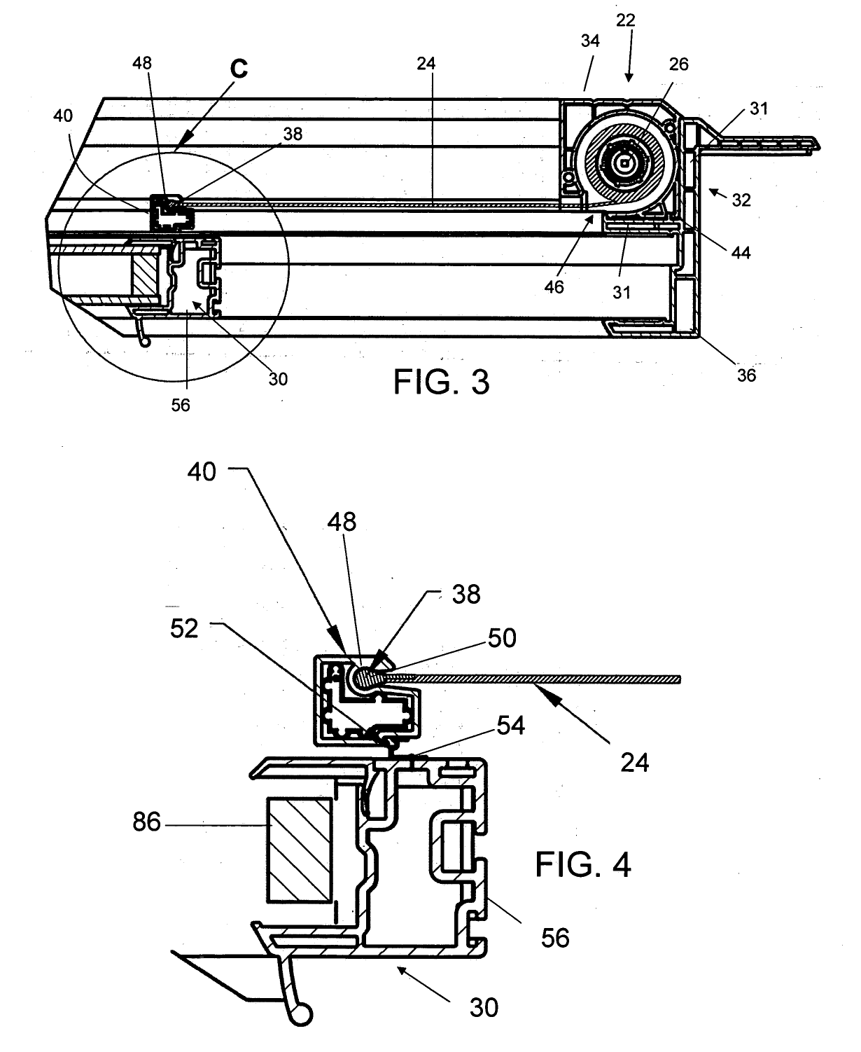

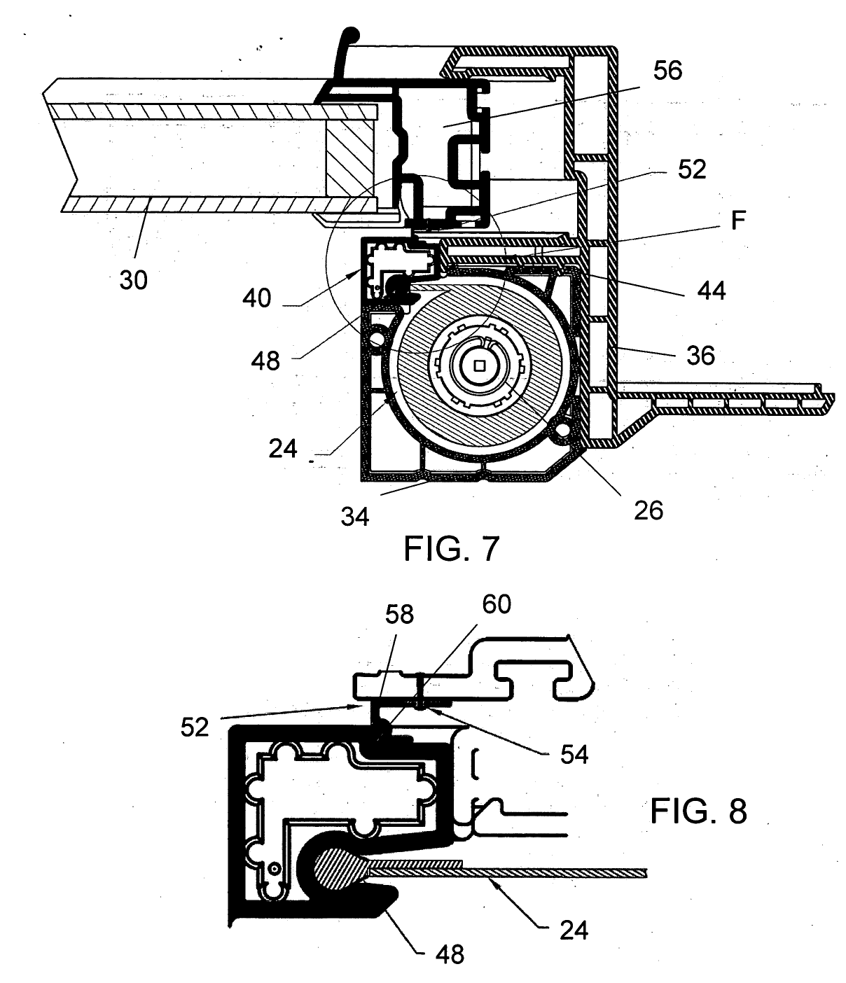

With reference now to FIGS. 3 and 4, the screen housing 34 is mounted to the external window frame 32 of the window assembly such that the housing is substantially recessed within the confines of the external frame, facilitating the overall esthetics of window. The housing is supported within an L-shaped recess defined by the frame. More particularly, the first vertical side 36 of the frame includes a ledge 31 disposed between the screen housing and the sliding panel 30 to accommodate the screen assembly. The housing is secured to the ledge via snap-fit attachments 44 (FIG. 7). Thus, the screen assembly can be easily removed for cleaning or servicing, as needed. In other embodiments, different means of attachment can be used. The screen and spool combination are centered within a cylindrical cavity defined within the housing and are protected therein when not deployed. The housing defines an opening 46 adjacent to the intermediate ledge from which the screen extends out of the housing.

As best seen in FIG. 4, the pull rail 40 securely receives the leading edge 38 of the screen within a conforming recess 48. More particularly, the recess is sized to receive a welt 50 extending the length of the leading edge. If desired, the screen can be detached from the pull rail by sliding out the welt (or spline) along the length of the recess. The pull rail is attached to the sliding panel 30 via a clip 52, which is attached to the sliding panel by rivets 54 (see also, FIG. 8). The pull rail and the clip are cooperatively configured to provide a snap-fit attachment to one another. In this manner, the pull rail can be detached from the sliding panel, as needed. For example, a user may want to open the sliding panel without having the screen follow to pass something through the window or simply for maintenance purposes.

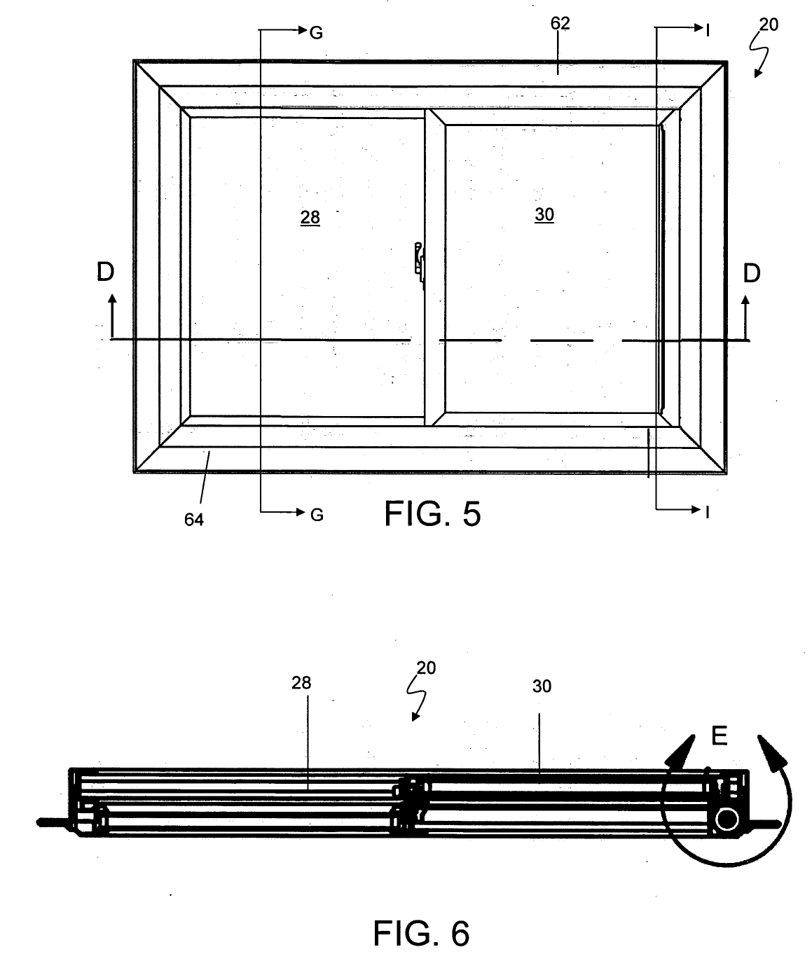

FIGS. 5-12 show the window assembly 20 with the sliding panel 30 closed. As best seen in FIG. 7, when closed, the sash 56 of the sliding panel extends beyond the housing 34 of the screen assembly 22, hiding the screen assembly from view to an observer within the building. Thus, the screen assembly appears to be integrally formed with the frame. In other embodiment, all or portions of the housing for screen can be integrally formed with the external frame. The pull rail 40 is sized to mate to the housing 34 in the opening 46 thereof, protecting the screen from debris when closed. As shown in FIG. 8, the pull rail defines a trailing edge 58 that is received within a forward-opening recess 60 of the clip 52 for a secure, snap-fit connection. The spool is biased to retract and re-roll the screen as the sliding panel is closed. In the exemplary embodiment, the spool is spring-biased, although various other methods known in the art can be used. When retracted, the screen assembly can be detached from its snap-fit attachments to the clip 52 and the first side 36 of the external frame.

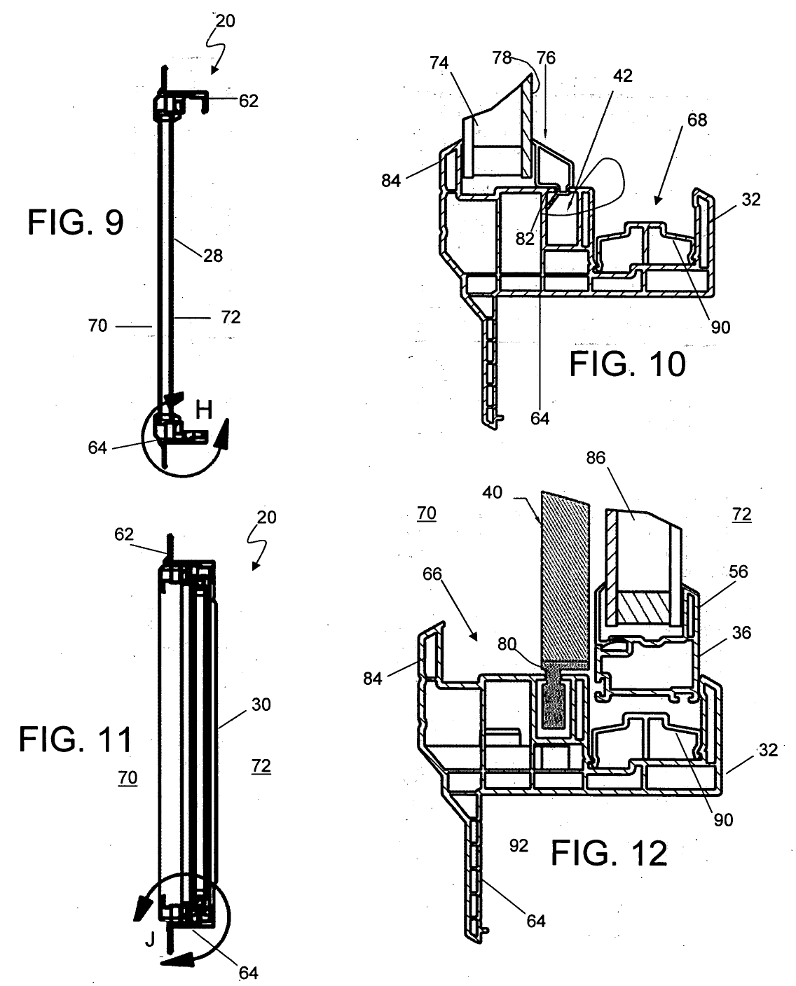

With reference particularly to FIGS. 9-12, the upper side 62 and the lower side 64 of the external frame 32 defines first and second sash pockets, i.e., a stationary pocket 66 and a sliding pocket 68, for securing the stationary and sliding panels 28, 30, respectively. In the exemplary embodiment, the stationary panel and pocket are closer to the external side 70 of the window assembly, whereas the sliding panel and pocket are closer to the interior side 72 of the window assembly. The frame defines the sash pockets and central channel 42 about the periphery thereof. In the exemplary embodiment, the first and second sash pockets 66, 68 are aligned parallel to one another on opposing sides of the central channel. For ease of illustration, the sash pockets and central channel are described with reference to the lower side 64 of the frame. In other embodiments, the pocket configurations and channel can vary among the four sides.

Also, in the exemplary embodiment, the sliding panel slides horizontally along the frame. It should be appreciated, however, that other embodiments are contemplated in which the sliding panel is arranged to slide vertically along the frame, e.g., single-hung windows. In such embodiments, the screen assembly can be horizontally aligned, e.g., along a bottom side of the frame such that the screen is pulled up as the sliding panel is opened.

As shown in FIG. 10, the stationary panel 30 includes a glazing 74 held in place with aid of a glazing bead 76. The glazing bead is received by the central channel 42 and presses against the interior side 78 of the glazing. The central channel includes an opening groove 80 (FIG. 12) defined by inwardly facing lips 82, which aid in securing the glazing bead in place. The glazing of the stationary panel is supported on its exterior side by a glazing tower 84 of the exterior frame 32. The glazing bead is secured in place without need of adhesives or caulking, but such materials can be used, if desired. In the exemplary embodiment, double-pane glazing is used in both panels, but various other types of glazing known in the art can be used with out departing from the present invention.

As shown in FIG. 12, the sliding panel 30 includes glazing 86 and the sash 56. The sash of the sliding panel is configured to be cooperatively received within the second sash pocket. An panel track 90 is disposed within the second sash pocket to aid in smooth sliding movement of the sliding panel, (a panel track is not typically used in vertical sliding i.e. single-hung windows). The screen is aligned along the central channel 42 and, in the exemplary embodiment, the side edges of the screen extends into the central channel, thereby concealing the edges. The pull rail 40 of the screen assembly includes an end portion 92 disposed within the central channel and securing in place with aid of the groove 80 of the channel. Thus, the end portion is confined to the central channel throughout the range of movement, as the sliding panel is opened and closed.

It should be appreciated from the foregoing that the present invention provides a window assembly incorporating a retractable screen assembly. The window assembly includes an external frame configured to interface with a rectangular opening in a wall. The frame defines a central channel on an inwardly facing side of the frame. The window assembly further includes a stationary panel and a sliding panel deposed within the frame. The stationary panel includes a glazing bead received within a portion of the central channel adjacent to the stationary panel to facilitate secure positioning of the panel. The sliding panel is configured to slide within the confines of the frame between open and closed positions. The retractable screen assembly includes a spool and a screen rolled about the spool, the screen having a leading end coupled to the sliding panel such that the screen is aligned along the central channel as the sliding panel slides between open and closed positions, the screen assembly having a portion disposed within the central channel.

Although the invention has been disclosed in detail with reference only to the exemplary embodiments, those skilled in the art will appreciate that various other embodiments can be provided without departing from the scope of the invention. Accordingly, the invention is defined only by the claims set forth below.

I claim:

1. A window assembly, comprising:
an external frame configured to interface with a rectangular opening in a wall, the frame defining a central channel on an inwardly facing side of the frame;
a stationary panel disposed within the frame and including glazing and a glazing bead, the glazing bead received within a portion of the central channel;
a sliding panel disposed within the frame, including glazing and a sash, the sliding panel configured to slide within the confines of the frame, between open and closed positions; and
a retractable screen assembly including a spool and a screen rolled about the spool, the screen having a leading end coupled to the sliding panel such that the screen is aligned along the central channel as the sliding panel slides between open and closed positions, the screen assembly having a portion disposed within the central channel.

2. A window assembly as defined in claim 1, wherein the frame defines a first sash pocket for receiving the stationary panel and a second sash pocket for receiving the sliding panel, the first and second sash pockets aligned parallel to one another on opposing sides of the central channel.

3. A window assembly as defined in claim 1, wherein the screen assembly includes a side edge disposed within the central channel.

4. A window assembly as defined in claim 1, wherein the leading edge of the screen is attached to pull rail, and the pull rail is attached to the sliding panel via a snap-fit, so as to be disconnectable.

5. A window assembly as defined in claim 4, wherein the pull rail includes an end portion disposed within the central channel such that operable movement of the pull rail is confined by the central channel.

6. A window assembly as defined in claim 5, wherein the external frame defines two dual use channels, spaced from each other on opposing sides of the frame.

7. A window assembly, comprising:
an external frame configured to interface with a rectangular opening in a wall, the frame having
a first pair of opposing sides, each side of the first pair defining first and second sash pockets aligned parallel with each other along the length of the side and defining a central channel aligned parallel with and disposed between the first and second sash pockets, along an inwardly facing side thereof, and
A second pair of opposing sides attached perpendicular to the first pair of opposing sides;
a stationary panel disposed within the frame and including glazing and two glazing beads, each glazing bead received within a portion of the corresponding central channel adjacent to the stationary panel;
a sliding panel disposed within the frame, including glazing and a sash, the sliding panel configured to slide within the confines of the frame between open and closed positions; and
a retractable screen assembly including
a housing secured along a first side of the second pair of opposing sides, the housing defining an elongated cavity;
a spool mounted for rotation within the housing;
a screen rolled about the spool, the screen having a leading end coupled to the sliding panel such that the screen is aligned along the central channel as the sliding panel slides between open and closed positions, the screen assembly having a portion disposed within the central channel.

8. A window assembly as defined in claim 7 wherein the leading edge of the screen is attached to pull rail, and the pull rail is attached to the sliding panel via a snap-fit, so as to be disconnectable.

9. A window assembly as defined in claim 7, wherein the housing is confined within the boundary of the external frame.

10. A window assembly as defined in claim 7, wherein the housing is attached to an exterior side of the frame.

11. A window assembly as defined in claim 7, wherein the leading edge of the screen is attached to pull rail, the pull rail configured for removably attached to the sliding panel via a snap-fit.

12. A window assembly as defined in claim 11, wherein the pull rail includes opposing end portions, each end portion disposed within the corresponding central channel such that operable movement of the pull rail is confined by the central channel.

13. A window assembly as defined in claim 12, wherein the screen includes opposing side edges, each disposed within the corresponding channel.

14. A window assembly, comprising:
an external frame configured to interface with a rectangular opening in a wall, the frame having
a first pair of opposing sides, each side of the first pair defining first and second sash pockets aligned parallel with each other along the length of the side of an inwardly facing side thereof, each side further defining a central channel disposed between the first and second sash pockets, and
A second pair of opposing sides attached perpendicular to the first pair of opposing sides;
a stationary panel secured to the frame within the first sash pockets;
a sliding panel disposed within the second sash pockets of the frame, the sliding panel configured to slide within the confines of the frame between open and closed positions; and
a retractable screen assembly including
a housing secured along a first side of the second pair of opposing sides, the housing defining an elongated cavity;
a spool mounted for rotation within the housing;
a screen rolled about the spool, the screen having a leading end coupled to the sliding panel such that the screen is aligned along the central channel as the sliding panel slides between open and closed positions, the screen assembly having a portion disposed within the central channel.

15. A window assembly as defined in claim 14, wherein each central channel is discontinuous, including a first segment adjacent to the stationary panel and a second segment adjacent to the sliding panel, wherein the first and second segments are collinear.

16. A window assembly as defined in claim 14, wherein each central channel extends substantially the length thereof.

17. A window assembly as defined in claim 16, wherein the stationary panel includes two glazing beads, each glazing bead received within a portion of the corresponding central channel adjacent to the stationary panel.
